(19) United States
(12) Patent Application Publication
(10) Pub. No.: US 2024/0321139 A1
(43) Pub. Date: Sep. 26, 2024

(54) METHOD AND SYSTEM FOR TEACHING LANGUAGES

(71) Applicant: Kevin Trombley, Dennard, AR (US)

(72) Inventor: Kevin Trombley, Dennard, AR (US)

(21) Appl. No.: 18/125,418

(22) Filed: Mar. 23, 2023

(51) Int. Cl. G09B 19/06; A63F 1/04

(52) U.S. Cl. CPC G09B 19/06; A63F 1/04; A63F 2001/0466

(57) ABSTRACT

The method and system are designed to teach language and alphabets to learners of all ages. The method features a deck of cards with letters, words, symbols, and/or pictures for different languages. Players can use game mechanics similar to solitaire. The game can be played solo or in a group. The game can be customized to suit the player's language level and preferences. The method and system offers a fun and innovative approach to language learning.

### 1. BACKGROUND

### Field

The method and system are directed to teaching languages. In particular, the method and system are directed to card games for teaching languages.

### Disclosed

### 2. DESCRIPTION OF THE RELATED ART

Learning a language can be challenging for many people, especially for those who are not exposed to it from an early age. Traditional teaching methods such as memorizing vocabulary and grammar rules can be boring and unengaging for some learners. Remembering different letters, symbols and the potential arrangements of letters and symbols can be difficult.

Hence, there is a need for an innovative and interactive way to teach symbols, language, and alphabets.

### SUMMARY

Briefly described an aspect of the present disclosure is a method for playing a game that facilitates learning of a language.

An aspect of the present disclosure is a method of playing a game. The method comprising dealing cards from a deck into at least two piles of cards, the deck comprising a plurality of cards, each of the plurality of cards comprising a suit selected from at least two different suits, each of the at least two different suits containing all letters from an alphabet; arranging cards dealt into at least two piles of cards so that a top card of each of the at least two piles of cards is showing to a player of the game; moving cards so that cards that are showing are organized in a predetermined arrangement; and dealing more cards and moving the cards that are showing until a predetermined goal is obtained.

Another aspect of the present disclosure is a method of playing a game. The method comprising dealing cards from a deck into at least two piles of cards, the deck comprising a plurality of cards, each of the plurality of cards comprising a suit selected from at least two different suits, each of the at least two different suits containing symbols from a language; arranging cards dealt into at least two piles of cards so that a top card of each of the at least two piles of cards is showing to a player of the game; moving cards so that cards that are showing are organized in a predetermined arrangement; and dealing more cards and moving the cards that are showing until a predetermined goal is obtained.

### BRIEF DESCRIPTION OF THE DRAWINGS

FIG. 1 shows an example of language cards that can be used in a game.

FIG. 2 is an exemplary arrangement of language cards that can be used in a game.

FIG. 3 is a diagram of a mobile system in which the game can be implemented.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components that would perform the same or a similar function as the components described herein are intended to be embraced within the scope of embodiments of the present disclosure.

The present method and system are a solitaire-like card game that uses cards to teach languages and the alphabet. The game includes a deck of cards with letters, symbols, pictures, and/or words. The letters, symbols, pictures, and/or words may be in different languages.

In an embodiment, the cards implement letters that are used to form English words. In an embodiment, the cards implement letters that are used to form Spanish words. In an embodiment, the cards implement letters that are used to form Russian words. In an embodiment, the cards implement letters that are used to form German words. In an embodiment, the cards implement letters that are used to form Scandinavian words. In an embodiment, the cards implement symbols that are used to form Hindi words. In an embodiment, the cards implement symbols that are used to form Chinese words. In an embodiment, the cards implement letters that are used to form Pinyin words. In an embodiment, the cards implement symbols that are used to form Japanese words. In an embodiment, the cards implement symbols that are used to form Korean words. In an embodiment, the cards implement symbols that are used to form Thai words. In an embodiment, the cards implement symbols and/or letters that are used to form any one of the languages that is or has been used.

In an embodiment, the game's objective is to move and arrange the letters, words, symbols and/or pictures in a predetermined manner to obtain a predetermined goal. For example, in an embodiment, the letters are moved in and arranged in manner that implements the game mechanics that are used in playing solitaire by using the mechanics of alphabetical order arrangement with the solitaire mechanics. In an embodiment, the cards can be moved and arranged to form words and sentences. By engaging in the game, players can learn the fundamentals of the alphabet, vocabulary, and grammar.

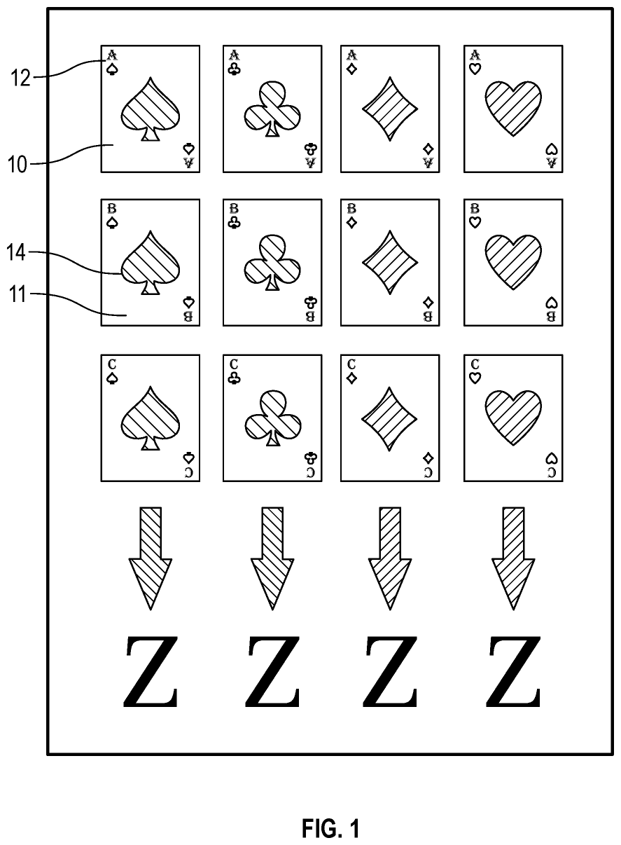

Turning to the figures, examples of the game and the particular mechanics which are implemented will now be discussed. FIG. 1 shows an example of cards that can be implemented in the language learning game. The cards 10 are shown with letters 12 that are representative of the letters that are used to form words in the English language. Each card 10 has a letter 12 placed thereon on the face 11 of the card 10.

As discussed above, letters, symbols, pictures, and/or words may be placed on each card 10, depending on the game that will be played and the goal of the game. Still referring to FIG. 1, the cards 10 each have a picture that represents a suit 14.

In FIG. 1, the suits 14 are spades, clubs, diamonds, and hearts. It should be understood that more suits 14 or less suits 14 may be used in playing the game. In an embodiment, the suits 14 are other pictures or symbols. The suits 14 are generally understood to be a picture or symbol that is placed on the card 10 that represents that all cards 10 that are of that suit 14 are related in some manner.

In FIG. 1, each of the suits 14 has the same letter 12. So for example there is a B of spades, a B of hearts, a B of diamonds and a B clubs. The same situation can be applied to Chinese symbols placed on cards 10. When implementing a language with more letters there would consequently be more cards 10. When implementing a language, such as Chinese, there may be cards representative of each character, or the most commonly used characters in the language. Lower case letters and upper-case letters can also be implemented.

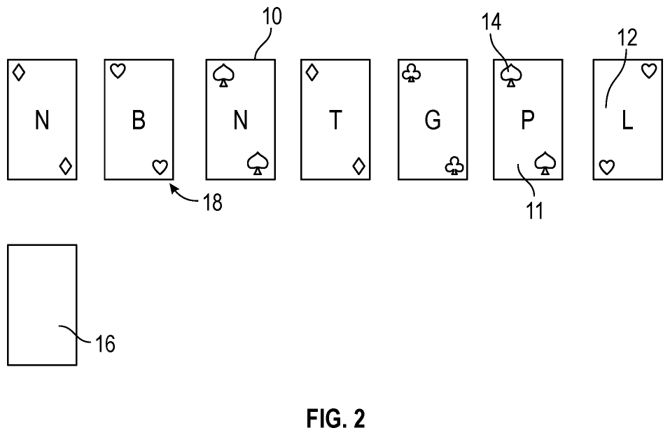

Turning to FIG. 2, the cards 10 are arranged into piles 18a-18g. Each of the piles 18a-18g of cards 10 can have a different number of cards 10, with the top card 10 of each pile being placed so that its face 11 is showing. Another of the piles 18a-18g may be placed so that its back 16 is showing. In FIG. 2 it is 18g. The pile 18g can be used to draw cards 10 from in the event there is no available card 10 to play.

In FIG. 2, the cards 10 are arranged so that there are seven cards 10 that are showing their faces 11. The piles 18a-18g are arranged so that there is a pile 18a having seven cards, a pile 18b having six cards, a pile 18c having five cards, a pile 18d having four cards, a pile 18e having three cards, a pile 18f having two cards, and one card 10 that is placed showing its face 11. The remaining cards are placed face down in pile 18g.

In the alphabetical order version of the game, cards 10 having the letters are placed on top of each other in alphabetical order. So a card 10 having the letter C could be placed on top of card 10 having the letter B. The cards 10 can also be required to be of corresponding suits 14 that then alternate in placement. For example, a diamond or heart could be placed on a club or spade, and vice versa.

If there is no potential play, cards are dealt from the face down pile 18g until a potential play can be made. This continues until all cards 10 have been played. In the embodiment shown in FIG. 2, this would result in four piles of played cards that correspond to the number of suits 14 that are used with the deck of cards 10.

Variations of this can be played, such as forming words instead of going in alphabetical order. In an embodiment, phrases can be formed using Chinese characters. In an embodiment, phrases can be formed using Japanese characters. In an embodiment, phrases can be formed using Thai characters. In an embodiment, phrases can be formed using Korean characters. In an embodiment, phrases can be formed using Sanskrit characters. In an embodiment, games can be played using Hebrew letters. In an embodiment, games can be played using Greek letters.

In addition to modern day languages, historical languages can be implemented as well. In an embodiment, phrases can be formed using hieroglyphics. In an embodiment, phrases can be formed using Sumerian characters. In embodiment, games can be played using Latin.

While solitaire game mechanics are mechanics of the game with which these language cards are utilized, other game mechanics may be implemented. For example, the games mechanics of gin rummy, hearts, and poker can be implemented. In an embodiment, it is contemplated that words are formed using the cards and used to create the most complex words or phrases from the hands of varying sizes being dealt.

In an embodiment, trick-taking games are played. In these games, players take turns playing cards, and the winner of each “trick” is determined by the highest-ranking card played, such as letter closest to the front of the alphabet or alternatively, the back of the alphabet.

In an embodiment, rummy games can be played. These games involve players trying to form sets or runs of cards in their hands using the letters.

In an embodiment, poker games can be played. Players bet on the strength of their hands, and the winner is determined by the highest-ranking hand. Score can be determined by words formed or matched letters.

In an embodiment, a collectible card game can be played. These games involve players building decks of cards and using them to battle against other players' decks. This can involve collecting letters and then creating longer words to use against each other.

In an embodiment, shedding card games can be played. Players try to get rid of all the cards in their hands, often by matching them to cards played by other players.

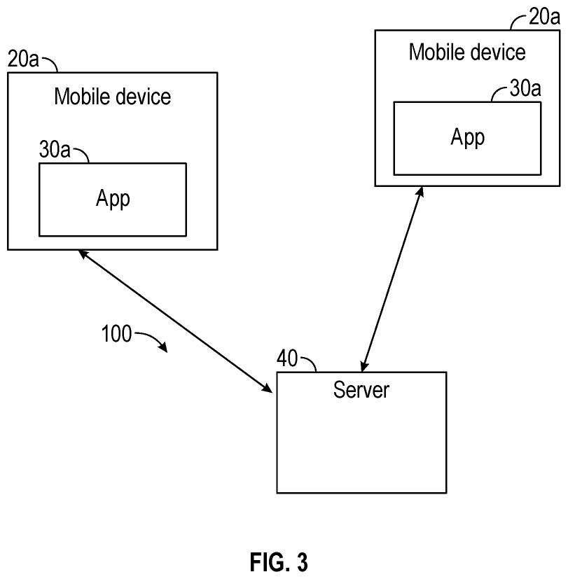

Turning to FIG. 3, shown is a system 100 in which the language game can be played. The system 100 comprises mobile device 20a and mobile device 20b. While two mobile devices are shown it is contemplated that more than one mobile device can be used or one person may play the language game by themselves on one device.

Each of the mobile devices 20a, 20b has apps 30a, 30b placed thereon. The apps 30a, 30b are used to access a server 40 that is adapted to match players of the language game with each other, or keep track of the specific language games and records that a person creates.

The use of applications on mobile devices allows people to access the game anywhere and be able to learn while waiting or otherwise not engaged in an activity. The mobile device may be able to download updates to cards or provide new game mechanics that the user can use.

In another embodiment, the card game comprises a deck of cards with a front side and a backside. The front side of each card has a letter of the alphabet, a picture, and a word associated with the picture. The backside of each card has the same information in a different language. The game can be played by one player or a group of players. The player shuffles the deck and places the cards face down in a row. The player then turns over the first card and tries to match it with the other cards in the row to form a word or a sentence. If the player makes a match, they keep the cards and continue playing until they can no longer make any matches. The player can then count the number of cards they have collected to determine their score. The game can be played in different languages, allowing the player to learn new vocabulary and grammar. The player can also challenge themselves by trying to form longer words and more complex sentences.

The present invention provides a way to teach language and the alphabet using a solitaire-like card game. The game is simple and engaging, making it an effective tool for language learners of all ages. The game can be played in different languages.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method of playing a game comprising:
dealing cards from a deck into at least two piles of cards, the deck comprising a plurality of cards, each of the plurality of cards comprising a suit selected from at least two different suits, each of the at least two different suits containing all letters from an alphabet;
arranging cards dealt into at least two piles of cards so that a top card of each of the at least two piles of cards is showing to a player of the game;
moving cards so that cards that are showing are organized in a predetermined arrangement; and
dealing more cards and moving the cards that are showing until a predetermined goal is obtained.

2. The method of claim 1, wherein at least six piles of cards are dealt.

3. The method of claim 1, wherein the alphabet comprises letters forming English words.

4. The method of claim 1, wherein the alphabet comprises letters forming Spanish words.

5. The method of claim 1, wherein the alphabet is the is Cyrillic alphabet.

6. The method of claim 1, wherein the predetermined arrangement is alphabetical order.

7. The method of claim 1, wherein the predetermined arrangement are words formed from the alphabet.

8. The method of claim 7, wherein the predetermined arrangement is a phrase formed from the words formed from the alphabet.

9. The method of claim 1, wherein the suit is selected from at least four different suits.

10. A deck of cards adapted to be used in the method of claim 1.

11. A method of playing a game comprising:
dealing cards from a deck into at least two piles of cards, the deck comprising a plurality of cards, each of the plurality of cards comprising a suit selected from at least two different suits, each of the at least two different suits containing symbols from a language;
arranging cards dealt into at least two piles of cards so that a top card of each of the at least two piles of cards is showing to a player of the game;
moving cards so that cards that are showing are organized in a predetermined arrangement; and
dealing more cards and moving the cards that are showing until a predetermined goal is obtained.

12. The method of claim 11, wherein at least six piles of cards are dealt.

13. The method of claim 11, wherein the symbols form Chinese words.

14. The method of claim 12, wherein the symbols are from Pinyin.

15. The method of claim 11, wherein the symbols are from the Cyrillic alphabet.

16. The method of claim 11, wherein the predetermined arrangement is a phrase.

17. The method of claim 11, wherein the predetermined arrangement is a group of related words.

18. The method of claim 11, wherein the suits are selected from types of animals.

19. The method of claim 11, wherein the suits are selected from a group consisting of hearts, clubs, diamonds, and spades.

20. The method of claim 11, wherein at least 10 piles of cards are dealt.
